(19) United States
(12) Patent Application Publication
(10) Pub. No.: US 2005/0219183 A1
(43) Pub. Date: Oct. 6, 2005

(54) Method for designing a structure for driving display devices

(75) Inventors: Leonardo Sala, Cornaredo (IT); Fulvio Bagarelli, Cremona (IT); Roberto Gariboldi, Lacchiarella (IT)

Correspondence Address: SEED INTELLECTUAL PROPERTY LAW GROUP PLLC, 701 FIFTH AVENUE, SUITE 6300, SEATTLE, WA, 98104-7092, US

(73) Assignees: STMicroelectronics S.r.I., Agrate Brianza (IT); DORA S.p.A., Aosta (IT)

(21) Appl. No.: 11/092,999

(22) Filed: Mar. 29, 2005

(30) Foreign Application Priority Data
Mar. 30, 2004 (EP) 04425227.8

(51) Int. Cl. G09G 3/36

(52) U.S. Cl. 345/89

(57) ABSTRACT

A method creates a display device driverby steps including: considering transmittance characteristics in relation to voltages applied to plural liquid crystal displays; defining a transmittance curve based on the voltage applied to said displays, for each display; applying a gamma correction, with different values of the gamma exponent, to each transmittance curve; applying a kickback correction to each curve; positioning branch points along said curves; determining a resistance value for each branch point and for each curve for each display; choosing a minimum resistance value for each branch point; choosing a maximum resistance value of for each branch point; calculating the difference between said minimum resistance value and said maximum resistance value for each branch point; defining for each branch point a fixed resistance value equal to said minimum resistance value; defining for each branch point an interval of values for a variable resistance equal to said difference.

### BACKGROUND OF THE INVENTION

1. Field of the Invention

The present invention refers to a method for designing a structure for driving display devices. In particular, it refers to a method that minimizes the structural complexity of the device generating the grey levels, guaranteeing the perfect compensation of the electro-optic non-linearities of the display material, of the dynamic kickback, and of the gamma corrections, with a voltage error not exceeding the required tolerance specification.

2. Description of the Related Art

An AMLCD (Active Matrix Liquid Crystal Display) is basically made up of a matrix of rows and columns of pixels. Each row of pixel shares a connecting line that connects the gates of the TFTs (Thin Film Transistor) of the pixels of the row. Each column shares a connecting line that supplies the drive signal to each pixel of the column. The signal on the row connection determines the firing and turnoff of the transistor. When a pulse is applied to the row line, the transistor turns on permitting the signal present on the column line to pass. The column signal is applied directly on the pixel and determines the formation of an electric field on the LC cell corresponding to the pixel, consequently altering the optical transmission properties of the light of the liquid crystals material (LC). An additional storage capacity is associated with the structure of the single pixel, with the purpose of maintaining the voltage on the LC cell even after the end of the pulse of the row electrode. The upper end of the storage capacitance is directly connected to the TFT, while the lower electrode can be connected to the common electrode (ITO) of the panel (cap-on-common structure), or to the line of the following or previous row (cap-on-gate). This latter structure is the most common as it enables a simpler, more economical manufacturing process of the display. The driving of the pixel of the matrix therefore comes about through the sequential firing of the rows and parallel transmission of the video signal for the columns, that is, for the pixels of each row. To avoid ionization of the LC material with consequent damaging thereof and degradation of the image quality by sticking effect, the electric field on the LC cell must be continuously inverted so as to annul the continuous component. The real information content applied to the pixel by the column driver is represented by the root-mean-square value (rms) of the AC voltage transmitted. The generation of intermediate grey levels between the firing and the turnoff state of a liquid crystal display pixel passes through the application of an active voltage between the effective firing voltage and the effective turn-off voltage on said pixel. The transmitted luminance curve of the LC material according to the active voltage applied to the cell is characterized by a marked non-linearity due to the electro-optical anisotropy of the liquid crystals.

The first task of the block for the generation of the grey scales is to compensate for the non-linearity, called Gamma Correction, so that various grey scales correspond to steps of luminance transmitted with uniform amplitude over the entire color scale, in relation to the voltage applied.

Liquid crystal displays exist on the market which use different varieties of LC materials, characterized by various transmittance-voltage curves, and for this reason the Gamma Correction device has to be able to be suitably adjusted to adapt to the different realities. Ideally in the absence of other compensations, the voltage curves, also called the gamma curves, for the positive and negative polarities should be exactly symmetrical in the two cases. The presence of parasitic capacitances between the gates and the drains of the TFT, and the use of high voltage gate impulses to fire the TFTs, causes the so-called voltage kickback effect, or charge injection, which constitutes an element of considerable disturbance on the information stored in the pixel. This disturbance due to the capacitive partitioning of the gate voltage applied, always has the same sign. In principle it could be compensated for statically and uniformly for all the pixels of the row. In reality the capacitance of the pixels is not constant, because it depends on the same voltage applied to the pixel. This further non-ideality introduces a dependency on the individual voltage of each pixel, making only the static compensation of the disturbance insufficient. In fact, the kickback is split up into two components: one is static equal for all the pixels, whose compensation is the task of the gate driver, and one is dynamic, variable from pixel to pixel, to be corrected by means of a source driver. The Gamma Correction must therefore also guarantee the compensation of the dynamic voltage kickback, caused by the parasitisms. This disturbance, being of equal sign for both polarities, determines the loss of symmetry of the gamma in the two cases, making it important to have two distinct curves available. Once again the different panels present on the market present electrical characteristics and parasitisms that can vary from model to model, therefore so as to guarantee the extreme versatility of the driver, the Gamma Correction device should be capable of accurately compensating all the intervening parasitic effects for all the possible applications.

In the mobile type of LCD applications, it is preferred to prevent the column driver, or source driver, from having also to supply negative voltages or work on a double dynamic range, therefore driving methods are resorted to such as VCOM switching for Cap-on-common structures and Four Level Driving (FLD) for Cap-on-gate structures. The latter is considered the best in terms of dissipation and image quality, and can be applied to the majority of displays on the market.

The origin of the term gamma can be found in the approximation of the luminance-voltage transmission curve in the field of the cathode ray tube monitors (CRT): the characteristic is expressed as a determined power of the straight line required for the display. In fact the exponent of this power function is called y, and the characteristic is called gamma characteristic or gamma curve. Still directly from the field of the CRTs, from the diction of gamma also originates that of Gamma Correction, referring to the correction applied to the video information to compensate for the non-linearity of the transmittance curve of the CRT monitors. This correction ensures that the video signal transmitted to the monitor is first subjected to an inverse curvature compared to that produced by the CRT itself, so that it reports in perfect linearity the visual information required with that obtained. Usually for the CRT monitors whose video signal is digital, the gamma correction is made at a digital level, directly by the control logic of the video peripheries, or at an even higher level directly via software. It is this latter via that has favored the diffusion and proliferation of images or films that are already “gamma corrected” with gamma factors higher than the unit. If the LCD monitor displayed these visual materials already corrected using a perfectly linear gamma curve, the result would be noticeably crooked, consequently it is necessary to re-process digitally the same material by the equipment integrating the display. Nevertheless, for equipment of the mobile type, such a re-processing of the input data could be excessively costly. It would be ideal that the Gamma Correction device was capable of activating a further third compensation for impressing a curvature of a certain gamma exponent at the overall transmittance-voltage characteristic. Basically we would have a counter-correction by totally analogical means, as if the LCD video emulated the non-linear characteristic of transmittance-voltage typical of a CRT monitor, drastically reducing the operations of the logics that manage the video signal.

In the sector of the LCD-TFT drivers for mobile applications, the simplest solutions of Gamma Correction known provide for the use of various resistive dividers that carry out the subdivision of the voltages for the generation of the suitable grey scales. These solutions nevertheless as well as entailing a high occupation of the area, limit the use of the driver to well determined LCD panels considered in the planning phase.

More articulated and versatile structures are known that make provision for an adjustable structure through digital means. The gamma curve is approximated by means of a piece-wise linear, whose branch points can be adjusted in voltage. A primary adjustable divider supplies the voltage references constituting the branch points of the piece-wise linear; these, once decoupled, produce by interpolation, by means of a further secondary not-adjustable divider, the grey levels of the gamma curve.

### BRIEF SUMMARY OF THE INVENTION

One embodiment of the present invention provides a method for designing a structure for driving display devices that is versatile and simple to actuate.

The method includes: considering the transmittance characteristics in relation to the voltage applied to a plurality of liquid crystal displays; defining a transmittance curve in relation to the voltage applied to said liquid crystals, for each liquid crystal display of said plurality; applying a gamma correction, with different values of the gamma exponent, to each previously defined curve; applying a kickback correction to each previously defined curve; positioning a plurality of branch points along said curves; determining a resistance value for each branch point and for each of said one curve for each display; choosing the value of minimum resistance for each branch point; choosing the value of maximum resistance per each branch point; calculating the difference between said value of minimum resistance for each branch point and said value of maximum resistance for each branch point; defining for each branch point a value of fixed resistance equal to said value of minimum resistance; defining for each branch point an interval of values for a variable resistance equal to said difference.

### BRIEF DESCRIPTION OF THE SEVERAL VIEWS OF THE DRAWINGS

The characteristics and the advantages of the present invention will appear evident from the following detailed description of an embodiment thereof, illustrated as non-limiting example in the enclosed drawings, in which:

FIG. 1 shows a typical curve of a liquid crystal;

FIG. 2 shows a typical inverse curve of a liquid crystal;

FIG. 3 shows a series of transmittance curves at the variation of the gamma exponent;

FIG. 4 shows a family of effective transmittance/voltage curves at the variation of the gamma exponent;

FIG. 5 shows the variation of the value of the capacitor of the liquid crystal Clc at the variation of the voltage applied;

FIG. 6 shows the minimum and the maximum curve for a type of liquid crystal;

FIG. 7 shows the diagram of an electrical structure for the generation of the grey levels;

FIG. 8 shows a detail of the diagram of FIG. 7.

### DETAILED DESCRIPTION OF THE INVENTION

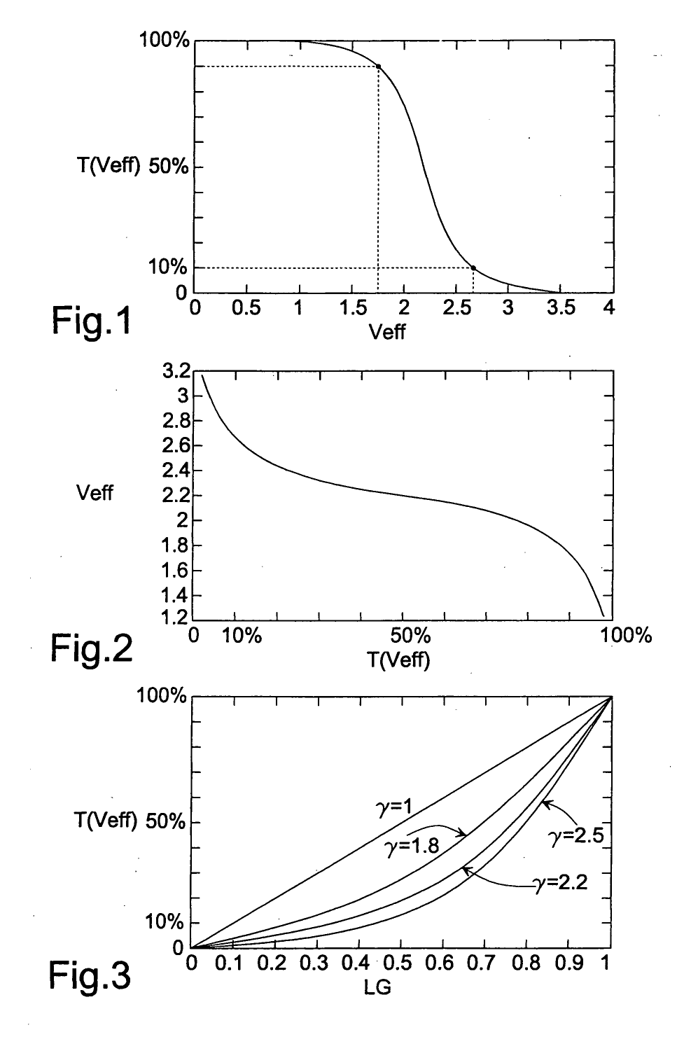

Starting from the data of luminance transmitted, at 10% and at 90%, of each liquid crystal taken in consideration, an accurate mathematic model is obtained for the transmittance curve of the LC material. A typical transmittance curve T(Veff) in relation to the active voltage Veff of a liquid crystal is shown in FIG. 1.

The mathematic model of the curve is obtained by means of an equation of the type
T(Veff)=A tan h(S(Veff−U))+O
where T(Veff) is the transmittance in relation to the voltage, and Veff is the active voltage applied to the liquid crystal. The parameters A, S, U and O are needed to make the suitable corrections to obtain a curve that adapts itself well to the various liquid crystals.

In this manner a curve for each type of liquid crystal considered is obtained.

The compensation of the electro-optical anisotropy of the LC cell is made considering the inverse of the curve obtained as model. Thus the inverse curves of those previously found are determined. That is, equations of the type, visible in FIG. 2, are found:
Veff(T)=U+(1/S) arctan h((T−O)/A)

In addition, a correction between the transmittance and the corresponding grey levels is also considered, by means of the application of a gamma exponent variable from 1-1.8-2.2-2.5, to the value of the grey levels LG; curves visible in FIG. 3.

In this manner a voltage/grey levels curve is obtained, which takes into account the compensations of non-linearity with gamma exponent.

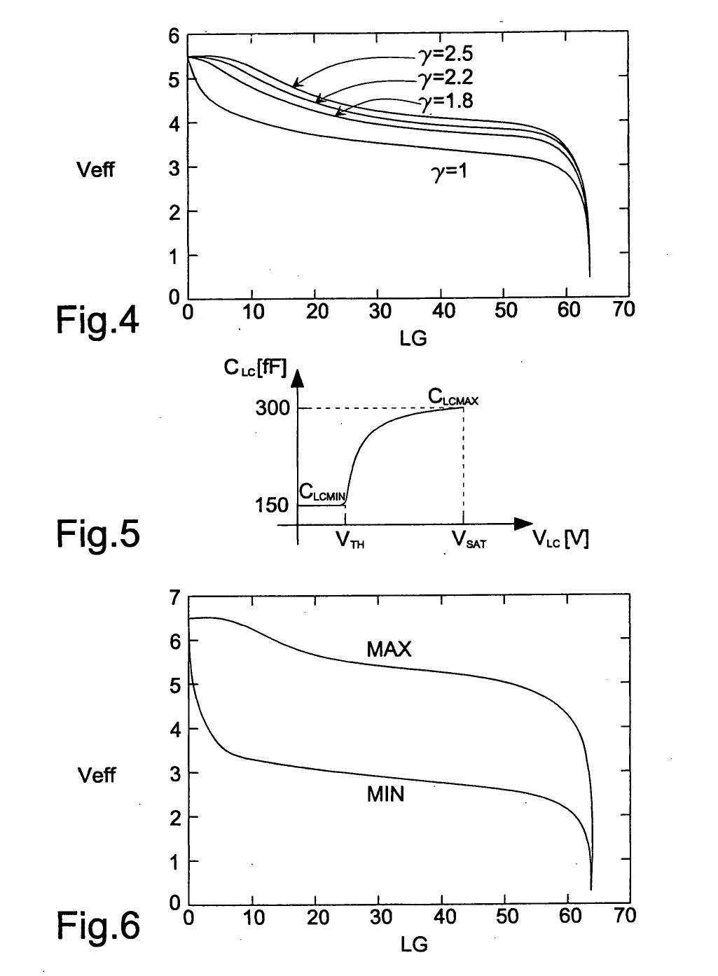

A family of curves is obtained for each liquid crystal, of the active voltage Veff in relation to the grey levels LG, having the gamma exponent as variable, like those shown in FIG. 4.

In addition the dynamic kickback correction (positive and negative) is applied, in particular for the drive by means of Four Level Driving (FLD). The calculation of the charge injection effects is carried out closely and over a wide spectrum of values for the parasitic terms and for the electric parameters of the panel. The capacitor of the cell has been simulated with a precise mathematic model. As can be seen in FIG. 5 the value of the capacitor of liquid crystal Clc, measured in fF, depends on the voltage applied Vlc. Initially (up to a voltage applied equal to Vth) it has a value Clcmin, then with the increase of the voltage it increases until it reaches the value Clcmax, with a voltage applied equal to Vsat.

To the curves previously determined the dynamic kickback correction is applied by modifying the active voltage in accordance with the distribution of the voltages on the capacitors present in the circuit and taking into consideration the capacitive variations of Clc.

A new family of curves is obtained, for each liquid crystal considered, of the active voltage Veff in relation to the grey levels LG, which takes the corrections applied into account. In FIG. 6, for one type of liquid crystal, the minimum and the maximum curves are shown; inside them there are other intermediate curves that are not represented.

At this point the number of points with which the curves are to be described is determined, for example 16, and the number of the grey levels that are required to be represented, for example 64.

Then a matrix of 64 columns is determined, that correspond to the 64 grey levels, and of N rows each one for each curve, linked to the type of liquid crystal/gamma exponent. If for example 5 types of liquid crystals are considered, and 4 exponent values, there are 20 curves.

In addition the electric diagram of the electric structure that generates the grey levels is determined.

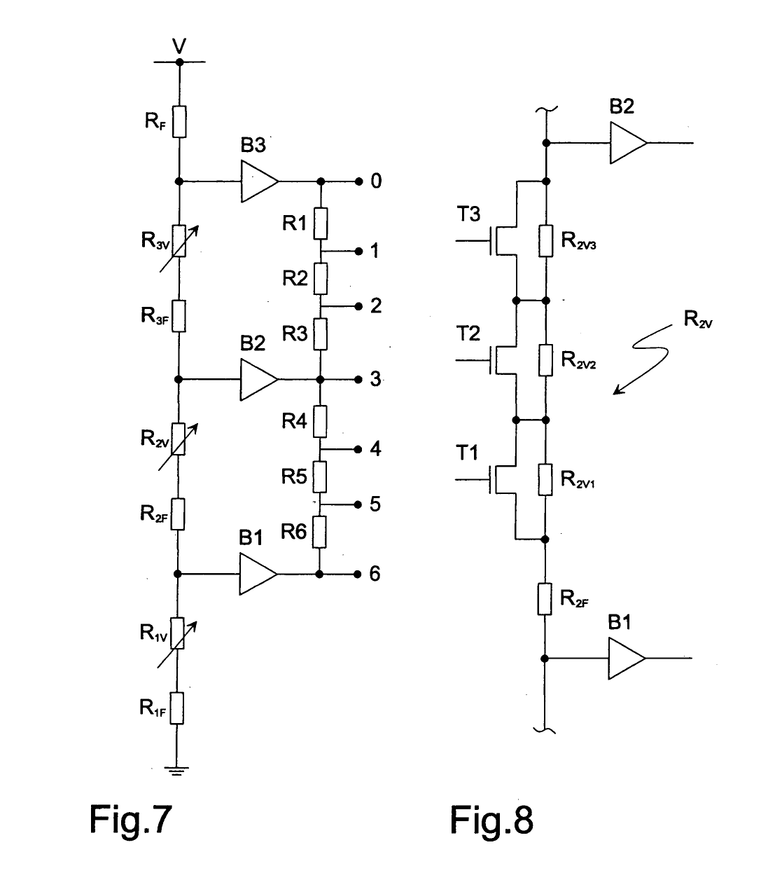

The basic architecture which is operated on consists of a totally adjustable divider, made up of fixed resistances and digitally variable resistances, as can be seen in FIGS. 7 and 8. In FIG. 7, for simplicity only 3 branch points have been considered, and 7 grey levels. Between the supply voltage V and ground a plurality of resistances are connected, in particular, starting from the supply voltage V is applied a fixed resistance Rf, a variable resistance R3v, a fixed resistance R3f, a variable resistance R2v, a fixed resistance R2f, a variable resistance R1v, a fixed resistance R1f. Between the resistance Rf and the resistance R3v there is the first branch point, between the resistance R3f and the resistance R2v there is the second branch point, between the resistance R2f and the resistance R1v there is the third branch point. At each branch point a buffer is applied, respectively B3, B2 and B1. At the output of the buffers, between each couple of them, three resistances in series are applied, respectively R1-R6. The 6 resistances R1-R6 have a total of 7 terminals that correspond to 7 grey levels that range from 0 to 6.

In FIG. 8 are represented the resistances that make the variable and fixed resistances between each couple of branch points of FIG. 7, in particular are represented the resistances R2v and R2f. The variable resistance R2v, is represented, for example, by three resistances R2v1, R2v2 and R2v3, connected in series, each one can be short-circuited by a transistor T1-T3 connected in parallel with the respective resistances, and controlled by a digital three-bit word, that commands the transistors T1-T3.

Thus the curves are represented with a piece-wise linear of 16 branch points, which, in accordance with the FIGS. 7 and 8, corresponds to set up 16 couples of fixed resistances of the type Rnf, and of variable resistances of the type Rnv, where n goes from 1 to 16. The intermediate sections, of interpolation between the branch points, not necessarily linear, are represented at least initially by 4 variable resistances of the type Rmvq, where m goes from 1 to 16 and q goes from 1 to 4, as in FIG. 8. The resistances Rmvq have values scaled in binary, that is if R2v1 has value VR, the resistance R2v2 has value 2*VR, and the resistance R2v3 has value 4*VR, and so on.

The positioning of the 16 branch points on the curves can be made by placing them equidistant, but preferably it is done by placing them at closer distances in the points in which the curve carries our greater changes in slope (towards the extreme values of Veff), and at greater distance in the points of the straighter curve (centre section).

Once the 16 branch points have been positioned, a matrix of 15 columns and N rows is considered preferably. The value of the fixed resistance Rf is set.

The values of the 16 resistances between the 16+1 branch points are determined, for each type of curve. To represent all the curves relating to a type of liquid crystal various resistance values are needed.

For each liquid crystal and for each resistance of the divider therefore a static contribution is identified (that is a value of minimum resistance Rmin) and an interval of variation (difference between the minimum and the maximum values of the resistances Rmax-Rmin).

The value Rmin of each branch point corresponds to the fixed resistance Rnf, and the interval Rmax-Rmin corresponds to the variable resistance Rnv.

A suitable algorithm of first order approximation (of the type that determines the difference of the maximum voltage and the minimum voltage that has to be available at the ends of the resistance, divided by a value of allowable tolerance) derives the number of voltage levels, and then the bit levels, necessary per each variable resistance. In this manner the number of transistors TN that have to be used is determined.

The voltages relative to the grey levels are determined, they are compared with the voltage values of the curves that have to be obtained and the error between the two values is calculated.

If the error exceeds a maximum preset error a bit is added either to the resistance of the previous branch point or to that of the successive branch point, preferably to the resistances of the previous branch point.

If instead the error is lower than a minimum preset error a bit is removed either from the resistance of the previous branch point or from that of the successive branch point, preferably from the resistances of the previous branch point.

All the reference branch points are controlled cyclically and at each bit increase the structure is reconstructed, again testing the voltage errors until the tolerance specifications are met by all the references.

Once an adjustable primary structure that is capable of supplying all 16 reference branch points with the required precision is obtained, the interpolation of the grey levels comprised between the branch points is proceeded with. To improve the precision of the interpolation constant steps between the levels are not taken, but each step is sized according to the average course of all the voltage curves.

In this manner the resistances R1-R6 are determined, placing 4 of them between each branch point and thus arriving at 64 grey levels.

All of the above U.S. patents, U.S. patent application publications, U.S. patent applications, foreign patents, foreign patent applications and non-patent publications referred to in this specification and/or listed in the Application Data Sheet are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method of creating a structure for driving display devices comprising the steps of:
considering transmittance characteristics in relation to voltages applied to a plurality of liquid crystal displays;
defining a transmittance curve based on the voltages applied to said liquid crystal displays, for each liquid crystal display of said plurality;
applying a gamma correction, with different values of a gamma exponent, to each transmittance curve to obtain gamma corrected curves for each liquid crystal display;
applying a kickback correction to each gamma corrected curve to obtain kickback corrected curves;
positioning a plurality of branch points along said kickback corrected curves;
determining a resistance value for each branch point of each kickback corrected curve for each liquid crystal display;
choosing a value of minimum resistance for each branch point;
choosing a value of maximum resistance for each branch point;
calculating a difference between said value of minimum resistance for each branch point and said value of maximum resistance for each branch point;
defining for each branch point a value of fixed resistance equal to said value of minimum resistance;
defining for each branch point an interval of values for a variable resistance equal to said difference; and
creating a voltage divider network having fixed resistances according to said minimum resistance for each branch point and variable resistances that are based on the defined interval values.

2. A method in accordance with claim 1 wherein positioning the plurality of branch points along said kickback corrected curves for each display comprises positioning said plurality of branch points equidistant to one another.

3. A method in accordance with claim 1 wherein positioning the plurality of branch points along said kickback corrected curves for each display comprises positioning a higher number of branch points in zones of said kickback corrected curves in which that have greater changes of slope.

4. A method in accordance with claim 1 wherein determining the resistance value for each branch point comprises determining a plurality of resistance values to be applied between each couple of branch points.

5. A method in accordance with claim 1, further comprising determining voltage values of a number of grey levels by means of the resistance values previously defined.

6. A method in accordance with claim 5 wherein said number of branch points is equal to 16 and said number of grey levels is equal to 64.

7. A method in accordance with claim 1 wherein the voltage divider network includes a plurality of fixed/variable resistance pairs connected between first and second voltage references and separated from one another by a respective branch node of a plurality of branch nodes, each fixed/variable resistance pair including one of the fixed resistances and one of the variable resistances.

8. A method in accordance with claim 7 wherein the voltage divider network further includes:
a plurality of buffers connected respectively between the branch nodes and a corresponding plurality of output nodes;
a plurality of groups of further fixed resistances, each group of further fixed resistances being connected between consecutive ones of the output nodes; and
a plurality of further output nodes positioned between consecutive ones of the further fixed resistances.

9. A method in accordance with claim 7 wherein each of the variable resistances includes a plurality of fixed resistors and a corresponding plurality of switches each in parallel with a respective one of the fixed resistors.

10. A method of creating a structure for driving a display device, comprising:
determining a plurality of branch points along a plurality of curves that have been corrected based on gamma correction values and kickback correction values;
determining a value of minimum resistance for each branch point;
determining a value of maximum resistance for each branch point;
calculating a difference between said value of minimum resistance for each branch point and said value of maximum resistance for each branch point; and
creating a voltage divider network having fixed resistances according to said minimum resistance for each branch point and variable resistances that are based on the defined interval values.

11. A method in accordance with claim 10 wherein determining the plurality of branch points comprises determining said plurality of branch points equidistant to one another.

12. A method in accordance with claim 10 wherein determining the plurality of branch points comprises positioning a higher number of branch points in zones of said curves in which that have greater changes of slope.

13. A method in accordance with claim 10, further comprising determining a resistance value for each branch point by determining a plurality of resistance values to be applied between each couple of branch points.

14. A method in accordance with claim 10 wherein the voltage divider network includes a plurality of fixed/variable resistance pairs connected between first and second voltage references and separated from one another by a respective branch node of a plurality of branch nodes, each fixed/variable resistance pair including one of the fixed resistances and one of the variable resistances.

15. A method in accordance with claim 14 wherein the voltage divider network further includes:
a plurality of buffers connected respectively between the branch nodes and a corresponding plurality of output nodes;
a plurality of groups of further fixed resistances, each group of further fixed resistances being connected between consecutive ones of the output nodes; and
a plurality of further output nodes positioned between consecutive ones of the further fixed resistances.

16. A method in accordance with claim 14 wherein each of the variable resistances includes a plurality of fixed resistors and a corresponding plurality of switches each in parallel with a respective one of the fixed resistors.

17. A display device driver, comprising:
a first voltage divider leg connected between first and second reference voltages, the first voltage divider leg including a plurality of fixed/variable resistance pairs separated from one another by a respective branch node of a plurality of branch nodes, each fixed/variable resistance pair including a fixed resistance and a variable resistance, each branch node thereby having a minimum voltage value determining by the fixed resistance of one of the fixed/variable resistance pairs that corresponds to the branch node and having a range of voltage values that is variable from the minimum voltage value to a maximum voltage value as determined by the variable resistances of the corresponding fixed/variable resistance pair.

18. The display device driver of claim 17, further comprising:
a plurality of buffers connected respectively between the branch nodes and a corresponding plurality of output nodes;
a plurality of groups of further fixed resistances, each group of further fixed resistances being connected between consecutive ones of the output nodes; and
a plurality of further output nodes positioned between consecutive ones of the further fixed resistances.

19. The display device driver of claim 17 wherein each of the variable resistances includes a plurality of fixed resistors and a corresponding plurality of switches each in parallel with a respective one of the fixed resistors.
